(19) United States
(12) Patent Application Publication
(10) Pub. No.: US 2024/0384950 A1
(43) Pub. Date: Nov. 21, 2024

(54) HEAT EXCHANGER, COMPOSITE MATERIAL FOR HEAT EXCHANGER, AND MANUFACTURING METHOD FOR HEAT EXCHANGER

(71) Applicant: ZHEJIANG SANHUA INTELLIGENT CONTROLS CO., LTD., Shaoxing City (CN)

(72) Inventors: JIANHUA TANG, Shaoxing City (CN); SHURUI YU, Shaoxing City (CN); HAI HUANG, Shaoxing City (CN); LINJIE HUANG, Shaoxing City (CN)

(21) Appl. No.: 18/786,496

(22) Filed: Jul. 27, 2024

Related U.S. Application Data
(63) Continuation-in-part of application No. PCT/CN2023/072969, filed on Jan. 18, 2023.

(30) Foreign Application Priority Data
Jan. 27, 2022 (CN) 202210100270.4

(51) Int. Cl. F28F 21/08

(52) U.S. Cl. CPC F28F 21/089; F28F 2265/00

(57) ABSTRACT

A heat exchanger includes a substrate and a coating covering at least part of a surface of the substrate. The coating includes a hydrophobic coating. The heat exchanger defines channels for fluid circulation. The hydrophobic coating includes a low surface energy silane-based material and a filler dispersed in the low surface energy silane-based material. The filler includes two types of particles of which each has a shape. The shapes of the two types of particles are different. A composite material for the heat exchanger and a manufacturing method for the heat exchanger are disclosed.

### CROSS-REFERENCE TO RELATED APPLICATIONS

The present application is a bypass continuation-in-part of International (PCT) Patent Application No. PCT/CN2023/072969, filed on Jan. 18, 2023, which further claims priority of a Chinese Patent Application No. 202210100270.4, filed on Jan. 27, 2022, the entire content of which is incorporated herein by reference.

### TECHNICAL FIELD

The present disclosure relates to a heat exchange device, and in particular to a heat exchanger, a composite material for the heat exchanger and a manufacturing method for the heat exchanger.

### BACKGROUND

In the related art, a hydrophobic sol is coated on a surface of the heat exchanger to form a hydrophobic coating. The hydrophobic coating makes the corrosive solution have a larger contact angle on the surface of the heat exchanger and is less likely to spread, reducing the direct contact area between the corrosive solution and the surface of the heat exchanger. Besides, the hydrophobic coating itself also has a certain blocking effect on corrosive medium. Therefore, the hydrophobic coating is able to improve the corrosion resistance of the heat exchanger. Usually, there are inevitably some microporous defects or pores inside the hydrophobic coating formed by hydrophobic sol. In order to increase the density of the hydrophobic coating and improve the barrier effect of the hydrophobic coating, a filler can be added to the hydrophobic sol to increase the density of the hydrophobic coating. Currently, most studies focus on the effect of filler content on the anti-corrosion effect of the hydrophobic coating, but less attention is paid to the influence of the shapes of the particles contained in the filler on the anti-corrosion effect of the hydrophobic coating.

In order to further improve the corrosion resistance of the heat exchanger, related technologies can also start from the shapes of the particles to improve the corrosion resistance of the heat exchanger.

### SUMMARY

An object of the present disclosure is to provide a heat exchanger with good corrosion resistance. Correspondingly, the present disclosure also provides a composite material for the heat exchanger, and a manufacturing method for the heat exchanger.

The present disclosure provides a heat exchanger, including:
a substrate, the substrate defining a channel for fluid circulation; and
a coating covering at least part of a surface of the substrate, the coating including a hydrophobic coating, the hydrophobic coating including a low surface energy silane-based material and a filler dispersed in the low surface energy silane-based material;
wherein the filler including two types of particles of which each has a shape; the shapes of the two types of particles being different.

The hydrophobic coating of the present disclosure includes the low surface energy silane-based material and the filler. The filler in the hydrophobic coating of the present disclosure includes two types of particles, each of the two types of particles has a shape, and the two types of particles have different shapes. The compounding of particles of different shapes is conducive to increasing the density of the coating and increasing the barrier effect of the hydrophobic coating on corrosive medium, thereby improving the corrosion resistance of the heat exchanger.

The present disclosure further provides a composite material for a heat exchanger, including:
a low surface energy silane-based material, the low surface energy silane-based material including a silane with a hydrophobic group grafted thereon; the hydrophobic group being selected from at least one of a hydrocarbon group, a halogen atom and a nitro group; and
a filler, the filler including two types of particles of which each has a shape, the shapes of the two types of particles being different.

The composite material of the present disclosure forms the hydrophobic coating containing particles of two shapes on the surface of the heat exchanger, thereby improving the corrosion resistance of the heat exchanger.

The present disclosure further provides a manufacturing method for a heat exchanger, including following steps:
providing a substrate, the substrate defining a channel for fluid circulation;
forming a rare earth conversion film on at least part of a surface of the substrate, to form a treated substrate; and
covering a composite material on at least part of a surface of the treated substrate, and curing to form a hydrophobic coating covering the at least part of the surface of the treated substrate; wherein the composite material comprises a low surface energy silane-based material and a filler; the filler comprises two types of particles of which each has a shape, and the shapes of the two types of particles are different.

The manufacturing method for the heat exchanger disclosed in the present disclosure is capable of forming the hydrophobic coating containing particles of two shapes on the at least part of the surface of the treated substrate, thereby improving the corrosion resistance of the heat exchanger.

### BRIEF DESCRIPTION OF DRAWINGS

FIG. 1 is a schematic diagram of a micromorphology of irregular-shaped particles in accordance with an embodiment of the present disclosure;

FIG. 2 is a schematic diagram of a microscopic morphology of three-dimensional dendritic particles in accordance with an embodiment of the present disclosure;

FIG. 3 is a schematic structural view of a heat exchanger in accordance with an embodiment of the present disclosure;

FIG. 4 is an enlarged schematic view of an assembly structure of some components of the heat exchanger in FIG. 3;

FIG. 5 is a schematic cross-sectional view of a hydrophobic coating on a surface of a substrate of the heat exchanger in accordance with an embodiment of the present disclosure;

FIG. 6 is a schematic cross-sectional view of a hydrophobic coating and a rare earth conversion film on a surface of a substrate of the heat exchanger in accordance with an embodiment of the present disclosure;

FIG. 7 shows a surface morphology of the samples of Comparative Example 1 and Comparative Example 2 in a 48 hour salt spray testing of the present disclosure;

FIG. 8 shows a surface morphology of the samples of Comparative Example 1 and Comparative Example 2 in a 96 hour salt spray testing of the present disclosure; and

FIG. 9 shows the surface morphology of the samples of Embodiment 1 and Comparative Example 1 in the 96 hour salt spray testing of the present disclosure.

### DETAILED DESCRIPTION

In order to better understand the technical solutions of the present disclosure, the embodiments of the present disclosure will be described in detail below with reference to the accompanying drawings.

It should be understood that the described embodiments are only some, but not all, of the embodiments of the present disclosure. Based on the embodiments in the present disclosure, all other embodiments obtained by those of ordinary skill in the art without making creative efforts fall within the protection scope of the present disclosure.

Most of the anti-corrosion coatings on the surface of heat exchanger products on the market today are chemical conversion coatings. For example, the anti-corrosion coating on the surface of aluminum heat exchangers is mostly a chemical conversion film (TCP) formed by passivation of chromium salts. Because hexavalent chromium is highly toxic and carcinogenic, the use of hexavalent chromium passivation coatings has been strictly prohibited at home and abroad. Currently, trivalent chromium is used in the market instead of hexavalent chromium for surface anti-corrosion treatment of aluminum products. However, the harm of trivalent chromium to the environment and human body cannot be ignored. Based on this, the development of green environmentally friendly coatings suitable for heat exchangers, and the formation of anti-corrosion coatings on the surface of heat exchangers by applying coatings, has become an important development direction of surface anti-corrosion technology for heat exchangers.

Some related technologies coat a surface of a heat exchanger with hydrophobic sol. The hydrophobic sol solidifies on the surface of the heat exchanger to form a hydrophobic coating. During the curing process, because the groups in the hydrophobic sol condense with the Me-OH on a surface of a metal substrate to form bonds, and the groups in the hydrophobic sol are also cross-linked to form bonds and form a network structure, the hydrophobic coating formed can be firmly combined with a substrate of the heat exchanger. The hydrophobic coating makes the corrosive solution have a larger contact angle on the surface of the heat exchanger and is less likely to spread, reducing the direct contact area between the corrosive solution and the surface of the heat exchanger. Besides, the hydrophobic coating itself also has a certain physical barrier or physical shielding effect on corrosive medium, which can reduce the contact between the metal substrate and external substances (such as oxygen, water or other corrosive substances). In this way, on the one hand, the chemical corrosion of acids, alkalis, etc., on the surface of the metal substrate is reduced or slowed down; on the other hand, because the oxygen and water in contact with the metal substrate are reduced, the electrode polarization process and depolarization process are slowed down, so the electrochemical corrosion on the surface of the metal matrix is also reduced or slowed down to a certain extent. As a result, the hydrophobic coating is able to improve the corrosion resistance of the heat exchanger.

The improvement of corrosion resistance of the hydrophobic coating mainly depends on its hydrophobic properties and its internal microstructure. The hydrophobic properties of the hydrophobic coating originate from the hydrophobic groups in the hydrophobic coating. The internal microstructure of the hydrophobic coating is greatly affected by the cross-linking degree of the hydrophobic sol. Generally, the coating formed by a sol with a small degree of cross-linking has more pores inside. The more pores there are, the less blocking effect the coating itself has. As the degree of cross-linking increases, the density, mechanical strength and hardness of the coating increase, and the barrier effect of the coating itself also increases. However, excessive cross-linking will increase the brittleness of the coating, leading to an increase in microcracks or even rupture on the coating surface. In order for the hydrophobic coating to adhere firmly to the metal substrate without causing more microcracks or even rupture inside the coating, the hydrophobic sol needs to have an appropriate degree of cross-linking. Usually there are some microporous defects or pores inside the hydrophobic coating formed by hydrophobic sol. These microporous defects or pores can easily become paths for corrosive medium to diffuse to the metal substrate. For this purpose, a filler can be added to the hydrophobic sol.

The filler consists of a plurality of particles. The particles that make up the filler are filled in the microporous defects or pores of the hydrophobic coating, which can block the transmission path of the corrosive medium, hinder the transmission and diffusion of the corrosive medium in the hydrophobic coating, and increase the density and thickness of the hydrophobic coating, thereby improving the blocking effect of the hydrophobic coating itself on corrosive substances. Currently, most research focuses on the effect of the filler content in the hydrophobic coating on the anti-corrosion effect of the hydrophobic coating, but less attention is paid to the effect of the shape of the particles contained in the filler on the anti-corrosion effect of the hydrophobic coating.

A first aspect of the present disclosure provides a heat exchanger. The heat exchanger defines at least one channel (for example, a plurality of channels) for fluid circulation. The heat exchanger includes a substrate having the channels and a coating covering at least part of a surface of the substrate. The coating includes a hydrophobic coating. The hydrophobic coating includes a low surface energy silane-based material and a filler dispersed in the low surface energy silane-based material. The filler includes two types of particles. Each of the two types of particles has a shape, and the two types of particles have different shapes. Of course, in some embodiments, the filler includes more than three types of particles in which at least two types of particles have different shapes.

The low surface energy silane-based material refers to a silane-based material with low surface energy. When the surface energy of the material is low, it can show certain hydrophobic properties.

The hydrophobic coating of the present disclosure includes the low surface energy silane-based material and the filler. The particles included in the filler are filled in the network structure of the low surface energy silane-based material, and are firmly combined with the substrate of the heat exchanger through the low surface energy silane-based material. Microporous defects or pores in the low surface energy silane-based material come in a variety of shapes. From the perspective of pore filling, the higher the shape matching between the particles and pores, the better the filling effect of the particles. For example, for irregular-shaped pores, the filling of irregular-shaped particles can achieve a better filling effect. For regular-shaped pores, it is necessary to fill them with particles that match them in order to achieve a better filling effect. The diversification of particle shapes is beneficial to the filling of pores. The filler in the hydrophobic coating of the present disclosure includes two types of particles. Each of the two particles has a shape, and the two types of particles have different shapes. The compounding of particles of different shapes enables the particles to have a good filling effect in the hydrophobic coating, which is beneficial to increase the density of the coating, increase the barrier effect of the hydrophobic coating on corrosive medium, and improve the corrosion resistance of the heat exchanger.

The filler is usually added in the form of adding one or more types of particles, rather than in the form of adding one or more particles. The number of each type of particles in the coating is measured in tens, hundreds, thousands, tens of thousands, tens of millions, hundreds of millions, thousands of billions, or even trillions. For example, one type of particles may include particles in numbers of 10, 10², 10³, 10⁴, 10⁵, 10⁶, 10⁷, 10⁸, 10⁹, 10¹⁰, etc. In other words, the addition of the filler focuses on the type of particles, not the number of particles. Therefore, when discussing the impact of the shapes of particles on the hydrophobic coating, the focus is not on the shape of one or more particles, but on the commonality in shape of particles included in one type of particles and the impact of the difference in shape between two or more types of particles. In the present disclosure, one type of particles includes particles of substantially the same chemical composition and shape. One type of particles corresponds to one chemical composition and one particle shape.

The shape of the particle is mainly related to the preparation process. Common

preparation processes include ball milling, airflow milling, gas atomization, water atomization, chemical methods, etc. Using different preparation processes, the shapes of the particles obtained are also different. For example, the powder particles obtained by airflow milling from the strip are plate-shaped, the powder particles prepared by water atomization or gas atomization are spherical, the silica powder particles prepared by the precipitation method are roughly spherical, and the silica powder particles prepared by the gas phase method are roughly three-dimensional dendritic. Affected by the preparation process conditions, the shapes of all particles included in one type of particles may not be exactly the same. In this case, a particle shape corresponding to one type of particles refers to the shape of the majority of the particles (for example, the number accounts for 50%, 60%, 70%, 80%, 90%, 99%) included in that type of particles. For example, due to the influence of the preparation process, if 99% of the particles of a compound A are spherical and a remaining 1% are in the shape of water droplets, we still describe the shape of the particles of the compound A as spherical. That is, deviations in the shape of a small number of particles caused by the preparation process are ignored.

In some embodiments, the shape of one of the two types of particles is irregular.

When particles are filled into the network structure of a low surface energy silane-based material, it does not mean all the particles are perfectly matched to the pores they fill. Therefore, when the particles are filled into the pores, there may be some unfilled gaps on the outer surface of the particles. Since the strength, hardness and wear resistance of the particles themselves are better than those of the low surface energy silane-based material, the gaps between the particles become the main path for the corrosive medium to penetrate the coating and reach the substrate of the heat exchanger. The tortuosity, length, etc., of the transmission path of the corrosive medium in the hydrophobic coating largely depend on the surface morphology of the particles, or the shapes of the particles.

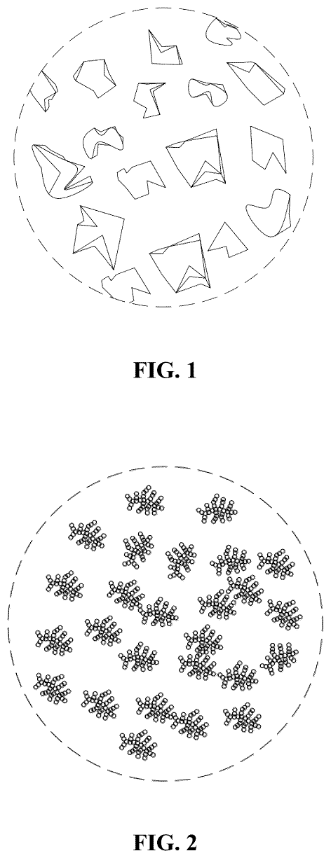

The shapes of particles can be divided into regular shapes and irregular shapes. The regular shapes usually refer to shapes that have certain mathematical rules in the dimensions of points, lines, or surfaces, such as spheres, ellipsoids, rods, needles, sheets, columns, hexahedrons, tetrahedrons, dendrites, and three-dimensional dendrites etc. Regular-shaped particles can usually be described by regular features in their shape. Irregular shapes are shapes that have no obvious mathematical rules in the dimensions of points, lines, and surfaces compared to the regular shapes, as shown in FIG. 1, for example.

Compared to the regular-shaped particles, the irregular-shaped particles can increase the tortuousness of the transmission path of the corrosive medium. Because whether it is between irregular-shaped particles or between irregular-shaped particles and regular shaped particles, the gaps are irregular. Therefore, the introduction of irregular-shaped particles will help hinder the penetration and diffusion of the corrosive medium in the hydrophobic coating, and prolong the time for the corrosive medium to penetrate the hydrophobic coating and reach the substrate of the heat exchanger, thereby improving the blocking effect of the hydrophobic coating on the corrosive medium, and improving the corrosion resistance of the heat exchanger. Besides, the irregular-shaped particles also have good slip resistance, which is beneficial to maintaining the consistency and stability of the hydrophobic coating.

In some embodiments, the chemical composition of the two types of particles is different. As mentioned before, the shapes of the particles are mainly affected by the preparation processes. In some cases, different types of particles can be prepared from the same material through different preparation processes. For example, plate-like particles are prepared from the aluminum oxide strip by airflow milling, spherical particles are prepared from the aluminum oxide strip by gas atomization, and then plate-like alumina particles and spherical alumina particles are added to the hydrophobic coating to achieve the compounding of particles of different shapes in the coating. In other cases, different types of particles can be prepared using different materials and through different preparation processes. For example, irregular alumina particles are compounded with gas phase silica three-dimensional dendritic particles. Since the particles prepared from different materials have different physical and chemical properties, such as strength, hardness, wear resistance, etc., adding these particles to the coating can enhance the hydrophobic coating in different aspects. In order to improve the overall performance of the hydrophobic coating, the present disclosure can also use particles with different chemical compositions.

In some embodiments, the irregular-shaped particles are selected from one of aluminum oxide, zinc oxide, zirconium oxide, titanium oxide, silicon oxide, lanthanum oxide, cerium oxide, praseodymium oxide, boron nitride, and barium sulfate. These compounds have good strength, hardness and wear resistance. Adding them as fillers to the hydrophobic coating can permanently enhance the corrosion resistance of the hydrophobic coating.

In some embodiments, the shape of at least one of the two types of particles is a regular shape which is selected from one of sphere, ellipsoid, rod, needle, sheet, column, hexahedron, tetrahedron, dendrite, and three-dimensional dendrite. The present disclosure also adds regular-shaped particles into the hydrophobic coating to increase the diversity of particle shapes. In some embodiments, the three-dimensional dendritic particles are gas phase silica particles. FIG. 2 schematically shows the shape of the gas phase silica particles.

In some embodiments, the regular-shaped particles are selected from one of aluminum oxide, zinc oxide, zirconium oxide, titanium oxide, silicon oxide, lanthanum oxide, cerium oxide, praseodymium oxide, boron nitride, graphene, graphene oxide, carbon nanotubes and barium sulfate.

In some embodiments, the particle sizes of the two types of particles range from 10 nm to 100 nm.

In the present disclosure, the particles are filled in the network structure of the low surface energy silane-based material. If the particle size is too large or too small, the blocking effect of the coating itself on the corrosive medium will be weakened. The particles with too large particle size will increase internal defects in the coating. The particles with too small size are easy to agglomerate in the coating and are not easily dispersed, resulting in the inability to evenly fill the micropores or pores of the network structure of the low surface energy silane-based material. In order not to affect the heat exchange performance of the heat exchanger, the hydrophobic coating on the surface of the heat exchanger of the present disclosure is thin. Correspondingly, the present disclosure selects the particle size range of the particles between 10 nm and 100 nm, so that the particles can be evenly filled in the network structure of the low surface energy silane-based material without significantly increasing the internal defects of the coating.

Due to the preparation process, the particle size of one type of particles is usually within a fixed particle size range. For example, the filler is aluminum dioxide particles; when describing the particle size range of the aluminum dioxide particles as 20 nm to 40 nm, it means that the particle sizes of the aluminum dioxide particles added to the hydrophobic coating are all in the range of 20 nm to 40 nm. Correspondingly, one type of particles also has an average particle size. In the present disclosure, the average particle size of one type of particles theoretically refers to the average particle size of the particles added to the hydrophobic coating.

In some embodiments, the two types of particles include a first type of particles and a second type of particles. The average particle size of the first type of particles is 2 to 10 times the average particle size of the second type of particles. The sizes of pores in the low surface energy silane-based material are also diverse. The present disclosure uses particles with different average particle sizes. On the one hand, it can improve the filling effect of the particles on the pores. On the other hand, the compounding of particles with different particle sizes is also conducive to increasing the density of the coating. In some embodiments, the first type of particles are regular-shaped particles and the second type of particles are irregular-shaped particles. Alternatively, the first type of particles are irregular-shaped particles and the second type of particles are regular shaped particles. In some embodiments, the content ratio of the first type of particles and the second type of particles in the hydrophobic coating is 1:1 to 1:5.

In some embodiments, both of the two types of particles are compounds that are insoluble or slightly soluble in water. In general, in water at 20° C., if the solubility is less than 0.01 g, it is poorly soluble, if the solubility is greater than 0.01 g and less than 1 g, it is slightly soluble, if the solubility is greater than 1 g but less than 10 g, it is soluble, and if the solubility is greater than 10 g, it is easily soluble. Insoluble or slightly soluble particles can stably exist in the hydrophobic coating for a long time, thereby achieving a lasting improvement in the anti-corrosion performance of the hydrophobic coating. In some embodiments, the resistivities of the two types of particles are both 10⁹ Ω·cm to 10²² Ω·cm. That is, the particles are prepared from insulating materials. In this way, the particles can also use insulating properties to slow down the transfer of ions between the cathode and anode in electrochemical corrosion cells, which has a certain hindering effect on the overflow of metal cations in the anode and the discharge effect generated by the cathode, that is, it has a resistance effect, reducing or slowing down the electrochemical corrosion on the surface of the metal substrate.

In some embodiments, at least part of the surface of at least one type of the two types of particles are grafted with a hydrophobic group. The hydrophobic group is selected from at least one of a hydrocarbon group, a halogen atom and a nitro group. In some embodiments, the hydrocarbon group may be —CₙH₂ₙ₊₁(n≥1), —CH═CH₂, or —C₆H₅; the halogen atom may be —F, —Cl, —Br, —I, or —At; the chemical formula of the nitro group is —NO2. The particles can be hydrophobically treated so that they have certain hydrophobic properties due to the grafted hydrophobic groups on the surface. Filling the hydrophobic coating with particles with certain hydrophobic properties can increase the hydrophobicity of the hydrophobic coating.

In some embodiments, the low surface energy silane-based material includes a silane with hydrophobic groups grafted on the surface. The hydrophobic group is selected from at least one of a hydrocarbon group, a halogen atom and a nitro group. In some embodiments, the hydrocarbon group may be —CₙH₂ₙ₊₁ (n≥1), —CH═CH₂, or —C₆H₅; the halogen atom may be —F, —Cl, —Br, —I, or —At; the chemical formula of the nitro group is —NO2. In some embodiments, the low surface energy silane-based material may be selected, for example, from one or more of heptadecafluorodecyltriethoxysilane, heptadecafluorodecyltrimethoxysilane, tridecafluoroctyltriethoxysilane, octadecyltrimethoxysilane and hexadecyltrimethoxysilane.

In some embodiments, in terms of parts by mass, the hydrophobic coating includes 0.5 to 1.5 parts of the low surface energy silane-based material and 0.1 to 5 parts of the filler.

In the context, unless otherwise stated, the percentages, ratios or parts referred to are by mass, wherein “parts by mass” refers to the basic measurement unit of the mass proportion relationship of multiple components. One part can represent any unit mass. For example, one part can be expressed as 1 g, 1.68 g, or 5 g, etc.

In the hydrophobic coating containing the filler, the filler content or the ratio of the filler to the low surface energy silane-based material is a key factor affecting the corrosion resistance. If the filler content is too small, the anti-corrosion effect of the coating will not be optimal. If the filler content is too large, the compatibility between the filler and the low surface energy silane-based material will decrease, and the filler will be unevenly dispersed in the hydrophobic coating, ultimately resulting in poor performance uniformity of the hydrophobic coating, increasing the defects and cracks inside the hydrophobic coating, even causing the coating to crack, and also reducing the hydrophobic performance of the coating. Under the ratio of the present disclosure, it can not only effectively maintain the good hydrophobic performance of the hydrophobic coating, but also significantly improve the barrier effect of the hydrophobic coating, thereby allowing the hydrophobic coating to improve the surface corrosion resistance of the heat exchanger to a better level.

In some embodiments, the static contact angle of the hydrophobic coating with water is greater than 150°, and the water droplet rolling angle of the hydrophobic coating is less than 5°. Under the ratio of the low surface energy silane-based material and the filler of the present disclosure, the hydrophobic coating has better hydrophobic properties.

In some embodiments, at least part of the surface of the substrate is covered with a rare earth conversion film which includes rare earth compounds. At least a portion of the rare earth conversion film is located between the substrate and the hydrophobic coating. The rare earth conversion film is located between the substrate and the hydrophobic coating, which means that one side of the rare earth conversion film is in direct contact with the substrate, and the other side of the rare earth conversion film is in direct contact with the hydrophobic coating. The hydrophobic coating is farther away from the substrate than the rare earth conversion film. The rare earth conversion film is sandwiched between the substrate of the heat exchanger and the hydrophobic coating. The hydrophobic coating is attached to the surface of the substrate of the heat exchanger through the rare earth conversion film. In some cases, the hydrophobic coating covered on the surface of the substrate of the heat exchanger may be in direct contact with the substrate of the heat exchanger; or there is a rare earth conversion film between the hydrophobic coating and the substrate of the heat exchanger; or a part of the hydrophobic coating is in direct contact with the substrate of the heat exchanger, and there is a rare earth conversion film between another part of the hydrophobic coating and the substrate of the heat exchanger. In some cases, the rare earth conversion film may be located entirely between the substrate of the heat exchanger and the hydrophobic coating; or a part of the rare earth conversion film is located between the substrate of the heat exchanger and the hydrophobic coating, and one side of another part of the rare earth conversion film is in direct contact with the substrate of the heat exchanger, and the other side of the another part of the rare earth conversion film is exposed to the external environment. That is to say, the top and the bottom of the another part of the rare earth conversion film are no longer covered with the hydrophobic coating, and only a portion of the surface of the heat exchanger is covered with the rare earth conversion film. The rare earth compounds in the rare earth conversion film can further improve the corrosion resistance of the heat exchanger.

In some embodiments, the rare earth compounds include rare earth oxides and/or rare earth hydroxides. For example, the rare earth compound may be cerium oxide (CeO₂), cerium trioxide (Ce₂O₃), cerium hydroxide (Ce(OH)₄), etc. Similarly, the rare earth compound may also be a compound of other rare earth clements, such as La, Pr, Nd, Pm, Sm, Eu, Gd, Tb, Dy, Ho, Er, Tm, Yb, Lu, Sc, and Y.

In some embodiments, the heat exchanger includes a collecting pipe, a fin and a plurality of heat exchange tubes. The heat exchange tubes are fixed to the collecting pipe. Inner cavities of the heat exchange tubes are in communication with an inner cavity of the collecting pipe. At least part of the fin is fixed between two adjacent heat exchange tubes. The substrate includes a substrate of at least one of the collecting pipe, the heat exchange tubes and the fin. That is, the heat exchanger is a microchannel heat exchanger. The hydrophobic coating, or the hydrophobic coating and the rare earth conversion film, is coated on at least part of a surface of at least one of the collecting pipe, the heat exchange tubes and the fin.

The following takes a microchannel heat exchanger as an example to illustrate the heat exchanger of the present disclosure.

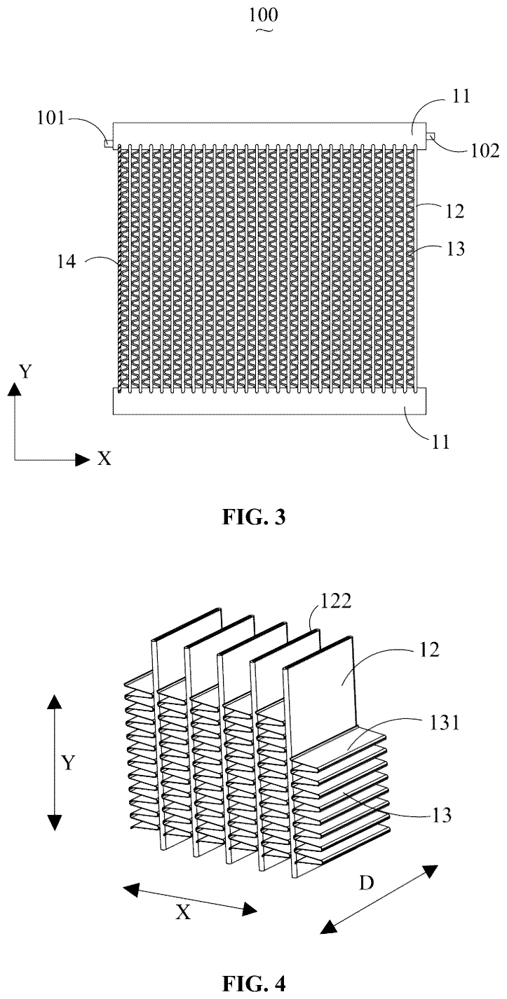

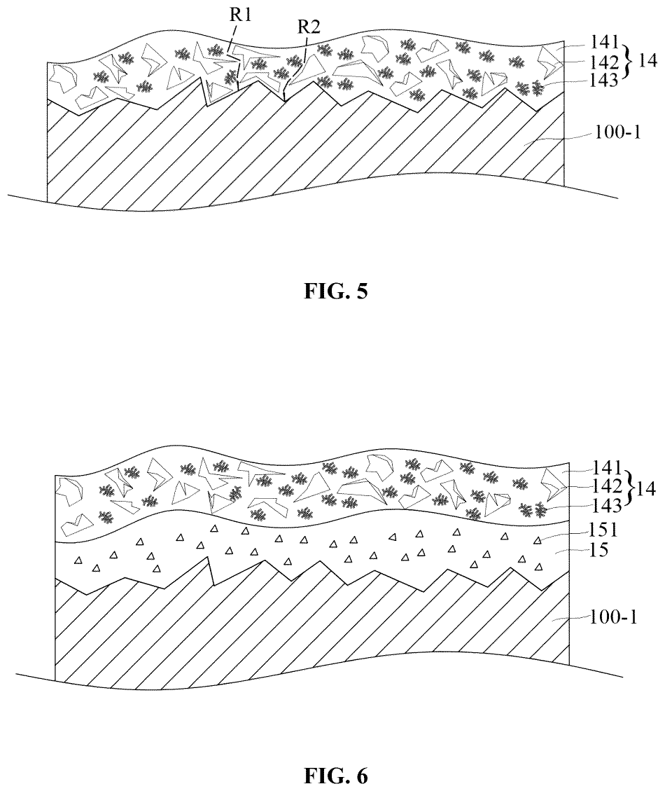

As shown in FIG. 3 and FIG. 4, the present disclosure provides a heat exchanger 100 which includes collecting pipes 11, a plurality of heat exchange tubes 12 and a plurality of fins 13. In the heat exchanger 100, the plurality of heat exchange tubes 12 are fixed to the collecting pipes 11. The heat exchange tubes 12 define a plurality of channels 122 for circulating refrigerant, and the plurality of channels 122 of the heat exchange tubes 12 are all in communication with inner cavities of the collecting pipes 11. At least part of the fins 13 is fixed between two adjacent heat exchange tubes 12. The collecting pipe 11 is provided with a fluid inlet 101 and a fluid outlet 102 which are in communication with the inner cavity of the collecting pipe 11, thereby facilitating fluid entry into the heat exchanger.

The plurality of heat exchange tubes 12 are disposed along a length direction of the collecting pipe 11. The length direction of the collecting pipe 11 may refer to the X direction in FIG. 3 or FIG. 4. The heat exchange tube 12 is a longitudinally extending tubular structure. A length direction of the heat exchange tube 12 may refer to the Y direction in FIG. 3 or FIG. 4. A width direction of the heat exchange tube 12 can refer to the D direction in FIG. 4. The dimension in the width direction of the heat exchange tube 12 is larger than the dimension in a thickness direction of the heat exchange tube 12. The thickness direction of the heat exchange tube 12 substantially coincides with the length direction of the collecting pipe 11.

Furthermore, the width direction of the heat exchange tube 12 and the length direction of the collecting pipe 11 are not in the same direction. In FIG. 4, the width direction (the D direction) of the heat exchange tube 12 is substantially perpendicular to the length direction (the X direction) of the collecting pipe 11.

In FIG. 3, the number of collecting pipes 11 is two. Both ends of the heat exchange tube 12 in the length direction are inserted into the inner cavities of the two collecting pipes 11, respectively. This type of heat exchanger is also often called a single-row heat exchanger in the industry. In some other embodiments, the number of collecting pipes 11 may be one or more than two. Correspondingly, the number of heat exchange tubes and fins is also set according to actual product needs.

In some embodiments, as shown in FIG. 4, the fins 13 are wavy in the length direction (the Y direction) of the heat exchange tube 12. The fins 13 include a plurality of fin units 131 disposed along the length direction of the heat exchange tube 12. The plurality of fin units 131 are connected in sequence along the length direction of the heat exchange tube 12. Positions where two adjacent fin units 131 are connected form a peak or trough in the corrugated structure corresponding to the fin 13. Furthermore, the fins 13 are fixed to the heat exchange tubes 12 at positions where two adjacent fin units 131 are connected. During assembly, components such as the collecting pipes 11, the fins 13 and the heat exchange tubes 12 can be assembled together in advance, the collecting pipes 11 and the heat exchange tubes 12 are fixed together through a brazing process, and the fins 13 are fixed between two adjacent heat exchange tubes 12.

The heat exchanger 100 includes a substrate 100-1 and a hydrophobic coating 14 covering at least part of a surface of the substrate 100-1. The substrate 100-1 is a substrate of at least one of the collecting pipes 11, the heat exchange tubes 12 and the fins 13.

FIG. 5 is a schematic cross-sectional view of the surface of the substrate of the heat exchanger in one embodiment of the present disclosure. As shown in FIG. 5, the surface of the substrate of the heat exchanger 100-1 is covered with the hydrophobic coating 14. The hydrophobic coating 14 includes a low surface energy silane-based material 141 and two types of particles dispersed in the low surface energy silane-based material. One type of particles has an irregular shape, and the other type of particles has a three-dimensional dendritic shape.

The irregular-shaped particles 142 and three-dimensional dendritic particles 143 are mixed and filled in the low surface energy silane-based material 141. In FIG. 5, R1 and R2 are used to show the transmission path of the corrosive medium in the hydrophobic coating 14. It can be seen from the figure that the combination of irregular-shaped particles and three-dimensional dendritic particles makes the path of the corrosive medium penetrating the hydrophobic coating 14 more tortuous, thereby improving the barrier effect of the hydrophobic coating 14 on the corrosive medium.

FIG. 6 is a schematic cross-sectional view of the surface of the substrate of the heat exchanger according to another embodiment of the present disclosure. As shown in FIG. 6, the surface of the substrate of the heat exchanger 100-1 is covered with a rare earth conversion film 15. The rare earth conversion film 15 includes a rare earth compound 151 (shown with a triangle). The rare earth conversion film 15 is located between the substrate of the heat exchanger 100-1 and the hydrophobic coating 14.

In other embodiments, the heat exchanger of the present disclosure may also be a plate heat exchanger, a tube-fin heat exchanger, a shell-tube heat exchanger, a circular tube-fin heat exchanger, or a heat exchanger including a water-cooling plate, a direct cooling plate, or the like for the flow of refrigerant or cooling liquid. That is to say, the hydrophobic coating, or the hydrophobic coating and the rare earth conversion film of the present disclosure can be used to provide surface anti-corrosion treatment not only for channel heat exchangers, but also for the plate heat exchangers, the tube-fin heat exchangers, the shell-tube heat exchangers, the tube-fin heat exchangers, or the heat exchanger including the water-cooling plate, the direct cooling plate, or the like.

A second aspect of the present disclosure provides a manufacturing method for a heat exchanger, which sequentially includes:
step S11, providing a substrate, the substrate defining a channel for fluid circulation;
step S21: forming a rare earth conversion film on at least part of a surface of the substrate, to form a treated substrate; and
step S31: covering a composite material on at least part of a surface of the treated substrate provided in step S11, and curing to form a hydrophobic coating covering the at least part of the surface of the treated substrate; wherein the composite material comprises a low surface energy silane-based material and a filler; the filler comprises two types of particles of which each has a shape, and the shapes of the two types of particles are different.

The characteristics and types of the low surface energy silane-based material; and the shape, particle size range, chemical composition and types of filler particles, etc., are referred to the previous articles and will not be repeated here.

In some embodiments, the substrate of the heat exchanger provided in step S11 undergoes surface sandblasting treatment. Specifically, in some embodiments, the surface sandblasting treatment specifically includes: sandblasting the surface of the substrate of the heat exchanger with 100 to 200 mesh white corundum, the sandblasting angle being 30° to 60°, the distance between a spray gun and a workpiece being 30 mm to 60 mm, and the number of sandblasting times being greater than or equal to 1; and then, using alcohol or water to ultrasonically clean or spray the surface of the heat exchanger, and drying it in the air or at 35° C. to 50° C. The sandblasting treatment can increase the roughness of the surface of the heat exchanger, thereby making the hydrophobic coating more firmly adhered to the surface of the substrate of the heat exchanger. In some embodiments, the roughness Ra of the surface of the substrate of the heat exchanger is 0.5 μm to 10 μm. In some embodiments, the roughness Ra of the surface of the substrate of the heat exchanger is 1 μm to 3 μm, for example, 1 μm, 1.2 μm, 1.4 μm, 1.6 μm, 1.8 μm, 2.0 μm, 2.2 μm, 2.4 μm, 2.6 μm, 2.8 μm or 3 μm, etc.

In some embodiments, in step S31, the method of covering the composite material on at least part of the surface of the treated substrate includes, but is not limited to, at least one of dipping, spraying, brushing, shower coating or roller coating.

In some embodiments, in step S31, the curing method may be, for example, drying in an oven. In some embodiments, the curing temperature ranges from 60°° C. to 180° C. In some embodiments, the curing time is 5 minutes to 35 minutes.

In some embodiments, before step S31 and after step S11, the method further includes: step S41: providing a composite material including a solvent, a low surface energy silane-based material and a filler; the filler including two types of particles; each of the two particles having a shape, and the shapes of the two types of particles being different. There is no restriction on the order of step S41 and step S21, which means step S41 can be performed before step S21 or after step S21.

In some embodiments, step S21 includes: preparing a rare earth conversion solution, immersing the heat exchanger in the rare earth conversion solution, taking out the heat exchanger, and then drying the surface of the heat exchanger. In other embodiments, the rare earth conversion solution can also be dip-coated, sprayed, brushed, shower-coated or rolled onto the surface of the heat exchanger.

In some embodiments, the rare earth conversion solution includes a rare earth raw material, an oxidizing agent and water.

In some embodiments, the rare earth conversion solution includes 1 to 3 parts of the rare earth raw material, 92.5 to 97.5 parts of water, and 1.5 to 4.5 parts of the oxidizing agent.

In some embodiments, a method for preparing the rare earth conversion solution includes: dissolving the rare earth raw material in water, and then adding the oxidizing agent to obtain the rare earth conversion solution.

In some embodiments, the preparation method of the rare earth conversion solution may include: in terms of parts by mass, dissolving 1 to 3 parts of the rare earth raw material in 92.5 to 97.5 parts of deionized water, and mixing to obtain an intermediate liquid; heating the intermediate liquid to 45° C. to 55° C., then adding 1.5 to 4.5 parts of the oxidizing agent to the system, and continue mixing to obtain the rare earth conversion solution.

The above-mentioned rare earth raw material is a raw material that can provide rare earth elements, such as a raw material that can provide cerium (Ce) elements. In some embodiments, the rare earth raw material includes, but is not limited to, one or a combination of at least two of hexahydrate cerium nitrate, anhydrous cerium nitrate, cerium chloride and its polyhydrated compounds, cerium sulfate and its polyhydrated compounds, and cerium acetate and its polyhydrated compounds. The above-mentioned cerium chloride and its polyhydrated compounds are anhydrous cerium chloride, polyhydrated compounds of cerium chloride, such as cerium chloride heptahydrate or cerium chloride octahydrate. Similarly, the above-mentioned cerium sulfate and its polyhydrated compounds are anhydrous cerium sulfate, or polyhydrates of cerium sulfate, such as cerium sulfate tetrahydrate. The cerium acetate and its polyhydrated compounds are anhydrous cerium acetate, or polyhydrated compounds of cerium acetate, such as cerium acetate trihydrate or cerium acetate tetrahydrate.

In some embodiments, the oxidizing agent includes, but is not limited to, at least one of hydrogen peroxide, sodium perchlorate, and tert-butyl hydroperoxide. For example, the oxidizing agent can be a hydrogen peroxide aqueous solution (the mass concentration of the hydrogen peroxide is about 27.5 wt. % to 30 wt. %), or the oxidizing agent can be sodium perchlorate, or the oxidizing agent can be an aqueous solution of tert-butyl hydroperoxide or an n-butanol solution of tert-butyl hydroperoxide (the mass concentration of the tert-butyl hydroperoxide is not less than 60 wt. %).

A third aspect of the present disclosure further provides a composite material for a heat exchanger. The composite material includes a solvent, a low surface energy silane-based material and a filler. The filler includes two types of particles of which each has a shape. The shapes of the two types of particles are different. The composite material can form an anti-corrosion coating containing the particles of two shapes on the surface of the heat exchanger, thereby improving the corrosion resistance of the heat exchanger.

In some embodiments, the solvent is selected from at least one of ethanol, methanol, and isopropyl alcohol.

The characteristics and types of the low surface energy silane-based material; and the shape, particle size range, chemical composition and types of filler particles, etc., are referred to the previous articles and will not be repeated here.

In some embodiments, in terms of parts by mass, the composite material includes 93.5 to 99.4 parts of the solvent, 0.5 to 1.5 parts of the low surface energy silane-based material, and 0.1 to 5 parts of the filler. The filler includes two types of particles of which each has a shape. The shapes of the two types of particles are different.

In some embodiments, the composite material provided in step S31 is self-made.

A fourth aspect of the present disclosure provides a method for preparing a composite material, including: mixing a solvent, a low surface energy silane-based material and a filler to obtain a composite material. The filler includes two types of particles of which each has a shape. The shapes of the two types of particles are different.

In the present disclosure, mixing may be mechanical stirring, ultrasonic dispersion, or other means of mixing. The preparation raw material can be added to the solvent all at once, or can be added to the solvent in two or more times. The present disclosure places no restrictions on the mixing method, adding sequence, adding method, and adding times. In some embodiments, at least one type of the two types of particles is added to the solvent in two or more time. In this way, it is beneficial to the dispersion of the filler in the composite material, so that the filler is evenly dispersed in the network structure formed by the low surface energy silane-based material.

In order to facilitate the understanding of the present disclosure, multiple sets of experimental verifications have been carried out. The present disclosure will be further described below in conjunction with specific embodiments and Comparative Examples. In order to facilitate performance testing, a plate is used instead of the heat exchanger for sample preparation. That is, a plate made of the same material as the heat exchanger is used, and the relevant paint is coated on the plate to form a coating for testing. In the actual preparation process, the surface treatment of the heat exchanger can adopt the same steps as the surface treatment of the plate in this embodiment.

### Embodiment 1

### Step 1: Surface Pretreatment

Sandblasting the plate using 120 mesh white corundum; the angle between the spray gun and the position to be coated being about 45°; the distance between the spray gun and the position to be coated being 50 mm; the number of sandblasting time being 1; then, spraying and cleaning the plate with absolute ethanol, and drying it at 40° C. for later use.

### Step 2: Formation of Rare Earth Conversion Film

Step 2.1: weighing 1 part of cerium nitrate hexahydrate into a beaker, adding 95.1 parts of deionized water, mechanically stirring until the solid is completely dissolved and the solution is colorless and transparent; heating the solution in a water bath to 50° C., adding 2.4 parts of n-butanol solution of tert-butyl hydroperoxide (the mass fraction of the tert-butyl hydroperoxide is greater than 70%), and continuing to stir and heat to 50° C., so as to prepare the rare earth conversion solution;

Step 2.2: immersing the plate that has been surface-pretreated in step 1 into the rare earth conversion solution prepared in step 2.1, keeping it at 50° C. for 40 minutes, and then blowing dry with cold air or letting it dry naturally. In this way, a rare earth conversion film is formed on the surface of the plate.

Wherein the main equations for the formation process of the rare earth conversion film are:

Al→Al³⁺+3e⁻;

O₂+2H₂O+4e⁻→4OH;

Ce³⁺+3OH⁻→Ce(OH)₃;

2Ce(OH)₃→Ce₂O₃+3H₂O.

### Step 3: Preparation of Composite Material

Step 3.1: weighing 98 parts of ethanol, 1 part of heptadecafluorodecyltrimethoxysilane, and 1 part of hydrophobic nanosilica (SiO₂) powder, ultrasonically dispersing for 15 minutes, and mechanically stirring for 2 hours to obtain a sol A;

Step 3.2: taking 98 parts of the sol A prepared in step 3.1 above, adding 1.5 parts of hydrophobic nano-silica powder and 0.5 parts of nano-alumina (Al₂O₃) powder, ultrasonically dispersing for 15 minutes, and mechanically stirring for 30 minutes to obtain a composite material.

Wherein hydrophobic nanosilica powder is obtained by treating gas phase silica with dimethyldichlorosilane (CAS: 75-78-5). The shape of gas phase silica particles is three-dimensional dendritic, and the particle size is 5 nm to 50 nm. The particles included in nano-alumina powder are irregular-shaped and have a particle size of 20 nm to 40 nm.

### Step 4: Coating the Plate

Dipping the entire plate covered with the rare earth conversion film in step 2 into the composite material prepared in step 3 for 2 minutes; after the dip coating is completed, placing it in an oven and curing at 120° C. for 20 minutes to obtain a plate with a rare earth conversion film and a hydrophobic coating.

### Embodiment 2 and Embodiment 3

The difference between Embodiments 2 and 3 and Embodiment 1 mainly lies in the preparation of the composite material in step 3, and the rest are the same as in Embodiment 1.

In Embodiment 2, preparing the composite material in step 3 includes:
Step 3.1: weighing 99 parts of ethanol, 0.5 parts of heptadecafluorodecyltrimethoxysilane, and 0.5 parts of hydrophobic nanosilica powder, ultrasonically dispersing for 15 minutes, and mechanically stirring for 2 hours to obtain a sol A.

Step 3.2: taking 99.4 parts of the sol A prepared in step 3.1 above, adding 0.5 parts of hydrophobic nano-silica powder and 0.1 part of nano-alumina powder, ultrasonically dispersing for 15 minutes, and mechanically stirring for 30 minutes to obtain the composite material.

In Embodiment 3, preparing the composite material in step 3 includes:
Step weighing 3.1:96.5 parts of ethanol, 1.5 parts of heptadecafluorodecyltrimethoxysilane, and 2 parts of hydrophobic nanosilica powder, ultrasonically dispersing for 15 minutes, and mechanically stirring for 2 hours to obtain a sol A;
Step 3.2: taking 97 parts of the sol A prepared in step 3.1 above, adding 2 parts of hydrophobic nano-silica powder and 1 part of nano-alumina powder, ultrasonically dispersing for 15 minutes, and mechanically stirring for 30 minutes to obtain the composite material.

### Comparative Example 1

The difference between Comparative Example 1 and Embodiment 1 lies in step 3. Preparing the composite material in step 3 of the Comparative Example 1 includes:
Step 3.1: weighing 98 parts of ethanol, 1 part of heptadecafluorodecyltrimethoxysilane, and 1 part of hydrophobic nanosilica powder, ultrasonically dispersing for 15 minutes, and mechanically stirring for 2 hours to obtain a sol A;
Step 3.2: taking 98 parts of the sol A prepared in step 3.1 above, adding 2 parts of hydrophobic nano-silica powder, ultrasonically dispersing for 15 minutes, and mechanically stirring for 30 minutes to obtain the composite material.

The rest are the same as in Embodiment 1.

### Comparative Example 2

The difference between Comparative Example 2 and Embodiment 1 lies in step 3. Preparing the composite material in step 3 of Comparative Example 2 includes:
Step 3.1: weighing 98 parts of ethanol, 1 part of heptadecafluorodecyltrimethoxysilane, and 1 part of hydrophobic nanosilica powder, ultrasonically dispersing for 15 minutes, and mechanically stirring for 2 hours to obtain a sol A;
Step 3.2: taking 98 parts of the sol A prepared in step 3.1 above, adding 2 parts of nano-alumina powder, ultrasonically dispersing for 15 minutes, and mechanically stirring for 30 minutes to obtain the composite material.

The rest are the same as in Embodiment 1.

### Performance Test

### 1. Hydrophobic Performance Test (Contact Angle Test)

The testing instrument used is a contact angle measuring instrument, which adopts the principle of optical imaging and uses image profile analysis to measure the sample contact angle. The contact angle refers to an angle formed by two tangent lines between a gas-liquid interface and a solid-liquid interface sandwiching the liquid phase, at a junction point of the solid-liquid-gas three-phase on a surface of a solid, when a drop of liquid is placed on a horizontal plane of the solid.

When testing, the contact angle measuring instrument and the computer connected to it are turned on, and the testing software is opened.

The sample is placed on a horizontal workbench; a microsampler is used to adjust the volume of droplet and the volume is generally about 1 μL; a droplet is formed on a needle; the knob is rotated to move the workbench so that a surface of the sample is in contact with the droplet; the workbench is then moved down, and the droplet will be left on the sample.

Testing and data analysis through testing software are conducted to obtain the contact angle in this area. The sample of each Embodiment and Comparative Example is tested at five different points and the average value is recorded as the contact angle of the sample of this Embodiment and Comparative Example.

The above contact angle test results show that the initial contact angles of the surface of the sample of Embodiments 1 to 3 and Comparative Examples 1 to 2 are all greater than 150°, showing a superhydrophobic state. This shows that the hydrophobic coating formed on the surface of the sample according to the various Embodiments of the present disclosure and the Comparative Examples have excellent hydrophobic properties.

### 2. Corrosion Resistance Test (Salt Spray Test)

The samples of the plate prepared in Embodiments 1 to 3 and Comparative Examples 1 to 2 are respectively subjected to salt spray test. The salt spray test refers to the test standard ASTM G85 and conducts acid salt spray test. Each sample is put into a salt spray box and it is taken out at certain intervals to observe the corrosion points on the surface. After the acid salt spray test, each sample is taken out to observe its surface corrosion and record the time when corrosion points appear.

Affected by the state of the salt spray box and the placement of the sample, even for samples of the same formula, the salt spray test results in different batches will vary greatly. Therefore, in order to better compare the corrosion resistance of plates prepared with different formulas, the present disclosure compares the samples in the salt spray test during the same period.

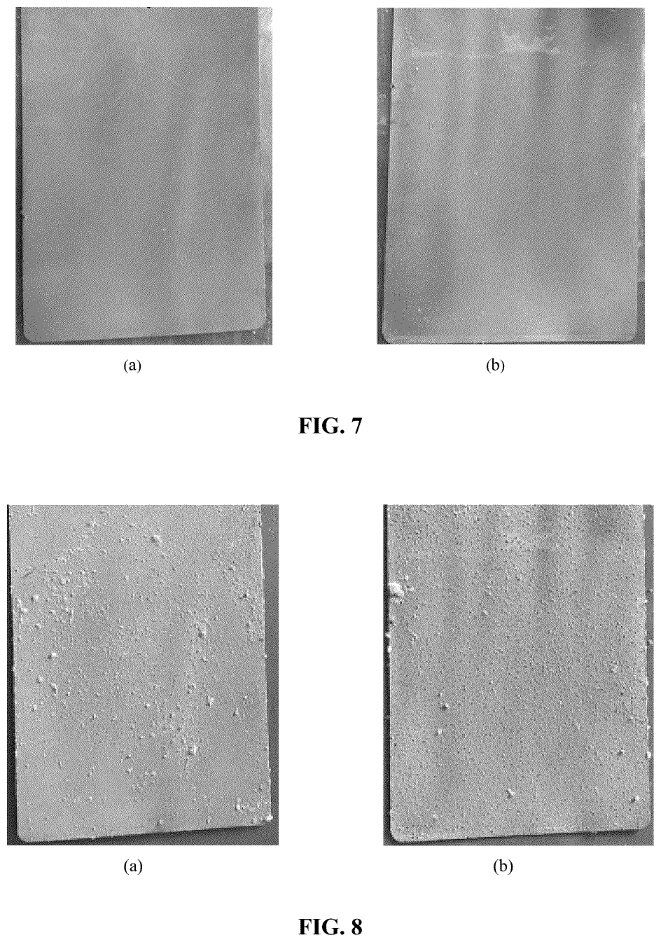

The present disclosure compares the samples of Comparative Example 1 and Comparative Example 2. After 48 hours of salt spray testing, the surface morphology of the samples of Comparative Example 1 and Comparative Example 2 is shown in FIG. 7, wherein FIG. 7(a) shows the surface morphology of the sample of Comparative Example 1, and FIG. 7(b) shows the surface morphology of the sample of Comparative Example 2. After 96 hours of salt spray testing, the surface morphology of the samples of Comparative Example 1 and Comparative Example 2 is shown in FIG. 8, wherein FIG. 8(a) shows the surface morphology of the sample of Comparative Example 1, and FIG. 8(b) shows the surface morphology of the sample of Comparative Example 2. It can be seen from FIG. 7 and FIG. 8 that the salt spray resistance properties of the samples of Comparative Example 1 and Comparative Example 2 are equivalent.

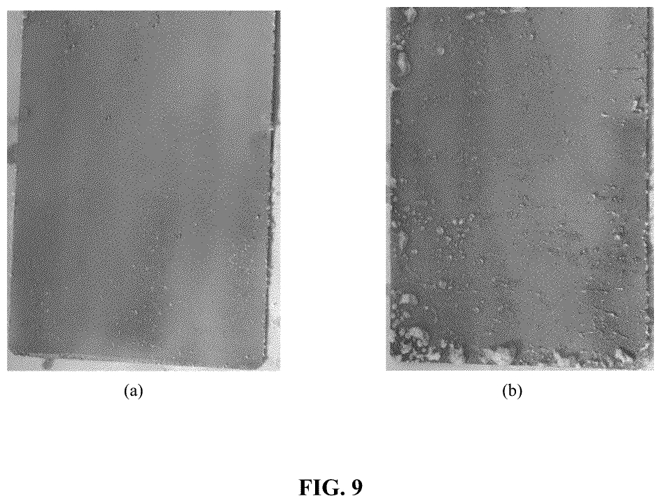

The present disclosure further compares the samples of Embodiment 1 with Comparative Example 1. After 96 hours salt spray testing, the surface morphology of the samples of Example 1 and Comparative Example 1 is shown in FIG. 9, wherein FIG. 9(a) shows the surface morphology of the sample in Example 1, and FIG. 9(b) shows the surface morphology of the sample of Comparative Example 1. As can be seen from FIG. 9, in the 96 hours salt spray testing, the rust spots on the surface of the sample of Example 1 are significantly less than those of Comparative Example 1. It can be seen that the corrosion resistance of the sample of Embodiment 1 is better than that of the sample of Comparative Example 1. This shows that the combination of nano-alumina particles and hydrophobic gas phase silica particles with different chemical compositions and particle shapes can significantly improve the corrosion resistance of the sample.

Although the embodiments of the present disclosure have been shown and described, it is understandable to those of ordinary skill in the art that various changes, modifications, substitutions and variations can be made to the embodiments without departing from the principles and purposes of the present disclosure, and the scope of the present disclosure is defined by the claims and their equivalents.

What is claimed is:

1. A heat exchanger, comprising:
a substrate, the substrate defining a channel for fluid circulation; and
a coating covering at least part of a surface of the substrate, the coating comprising a hydrophobic coating, the hydrophobic coating comprising a low surface energy silane-based material and a filler dispersed in the low surface energy silane-based material;
wherein the filler comprising two types of particles of which each has a shape; the shapes of the two types of particles being different.

2. The heat exchanger according to claim 1, wherein the shape of at least one of the two types of particles is a regular shape which is selected from one of sphere, ellipsoid, rod, needle, sheet, column, hexahedron, tetrahedron, dendrite, and three-dimensional dendrite.

3. The heat exchanger according to claim 2, wherein one of the two types of particles has an irregular shape, and a remaining one of the two types of particles has the regular shape;
the particle with the irregular shape is selected from one of aluminum oxide, zinc oxide, zirconium oxide, titanium oxide, silicon oxide, lanthanum oxide, cerium oxide, praseodymium oxide, boron nitride and barium sulfate;
the particle with the regular shape is selected from one of aluminum oxide, zinc oxide, zirconium oxide, titanium oxide, silicon oxide, lanthanum oxide, cerium oxide, praseodymium oxide, boron nitride, graphene, graphene oxide, carbon nanotubes and barium sulfate.

4. The heat exchanger according to claim 3, wherein a ratio of a content of the particles with the irregular shapes and the particles with the regular shapes in the hydrophobic coating is 1:1 to 1:5.

5. The heat exchanger according to claim 1, wherein a particle size range of each of the two types of particles is from 10 nm to 100 nm.

6. The heat exchanger according to claim 1, wherein the two types of particles comprise a first type of particles and a second type of particles, an average particle size of the first type of particles is 2 to 10 times an average particle size of the second type of particles.

7. The heat exchanger according to claim 1, wherein both of the two types of particles are compounds insoluble or slightly soluble in water.

8. The heat exchanger according to claim 1, wherein a resistivity of each of the two types of particles is 10⁹ Ω·cm to 10²² Ω·cm.

9. The heat exchanger according to claim 1, wherein at least part of the particles of at least one of the two types of particles is grafted with a hydrophobic group which is selected from at least one of a hydrocarbon group, a halogen atom and a nitro group.

10. The heat exchanger according to claim 1, wherein the low surface energy silane-based material comprises a silane grafted with a hydrophobic group thereon; and the hydrophobic group is selected from at least one of a hydrocarbon group, a halogen atom and a nitro group.

11. The heat exchanger according to claim 1, wherein the coating comprises a rare earth conversion film covering at least part of the surface of the substrate; the rare earth conversion film comprises a rare earth compound; and at least a portion of the rare earth conversion film is located between the substrate and the hydrophobic coating.

12. The heat exchanger according to claim 1, wherein the heat exchanger comprises a collecting pipe, a fin and a plurality of heat exchange tubes; the heat exchange tubes are fixed to the collecting pipe; inner cavities of the heat exchange tubes are in communication with an inner cavity of the collecting pipe; at least part of the fin is fixed between two adjacent heat exchange tubes; the substrate comprises a substrate of at least one of the collecting pipe, the heat exchange tubes and the fin.

13. A composite material for a heat exchanger, comprising:
a low surface energy silane-based material, the low surface energy silane-based material comprising a silane with a hydrophobic group grafted thereon; the hydrophobic group being selected from at least one of a hydrocarbon group, a halogen atom and a nitro group; and
a filler, the filler comprising two types of particles of which each has a shape, the shapes of the two types of particles being different.

14. The composite material according to claim 13, wherein the shape of at least one of the two types of particles is a regular shape which is selected from one of sphere, ellipsoid, rod, needle, sheet, column, hexahedron, tetrahedron, dendrite, and three-dimensional dendrite.

15. The composite material according to claim 13, wherein a particle size range of each of the two types of particles is from 10 nm to 100 nm.

16. The composite material according to claim 13, wherein at least part of the particles of at least one of the two types of particles is grafted with a hydrophobic group which is selected from at least one of a hydrocarbon group, a halogen atom and a nitro group.

17. The composite material according to claim 13, wherein, in terms of parts by mass, the composite material comprises: 93.5 to 99.4 parts of a solvent, 0.5 to 1.5 parts of the low surface energy silane-based material, and 0.1 to 5 parts of the filler.

18. A manufacturing method for a heat exchanger, comprising following steps:
providing a substrate, the substrate defining a channel for fluid circulation;
forming a rare earth conversion film on at least part of a surface of the substrate, to form a treated substrate; and
covering a composite material on at least part of a surface of the treated substrate, and curing to form a hydrophobic coating covering the at least part of the surface of the treated substrate; wherein the composite material comprises a low surface energy silane-based material and a filler; the filler comprises two types of particles of which each has a shape, and the shapes of the two types of particles are different.

19. The manufacturing method according to claim 18, wherein preparing the rare earth conversion solution comprises following steps:
in terms of parts by mass, dissolving 1 to 3 parts of a rare earth raw material in 92.5 to 97.5 parts of deionized water, and mixing to obtain an intermediate liquid; heating the intermediate liquid to 45° C. to 55° C., then adding 1.5 to 4.5 parts of oxidizing agent, and continue mixing to obtain the rare earth conversion solution;
wherein the rare earth raw material is selected from one or a combination of at least two of cerium nitrate hexahydrate, anhydrous cerium nitrate, cerium chloride and its polyhydrated compounds, cerium sulfate and its polyhydrated compounds, cerium acetate and its polyhydrated compounds; the oxidizing agent is selected from at least one of hydrogen peroxide, sodium perchlorate and tert-butyl hydroperoxide.

20. The manufacturing method according to claim 18, wherein before forming the rare earth conversion film on at least part of the surface of the substrate, the manufacturing method comprises a following step:
sandblasting at least part of the surface of the substrate with 100 to 200 mesh abrasives.
